(19) United States
(12) Patent Application Publication
(10) Pub. No.: US 2019/0391592 A1
(43) Pub. Date: Dec. 26, 2019

(54) POSITIONING SYSTEM

(71) Applicant: Merien BV, Eindhoven (NL)

(72) Inventor: Merien Ten Ten Houten, Eindhoven (NL)

(21) Appl. No.: 16/012,783

(22) Filed: Jun. 20, 2018

(51) Int. Cl. G05D 1/02; H04N 5/247; G06T 7/557; H04N 5/232; G05D 1/00

(52) U.S. Cl. CPC G05D 1/0246; H04N 5/247; G06T 7/557; G06K 9/00805; G05D 1/0088; G06T 2207/10028; H04N 5/23296

(57) ABSTRACT

A positioning system for use in a vehicle comprising a plenoptic camera with a field-of-view arranged for obtaining a light-field image based on the field-of-view of an area, wherein the positioning system further comprises a processor unit arranged for generating a depth map based on the image, whereby the depth map includes location information for objects in the image. Furthermore, a control unit is arranged for using the depth map for identification and/or classification of said objects, whereby the control unit is further arranged for determining of a relevance of said objects in relation to a first speed and/or a direction of the vehicle and, based on said location information and determined relevance, generating a proposal for a second speed and/or direction of the vehicle.

### TECHNICAL FIELD

The present invention relates to positioning systems for use in a vehicle. More particular the invention relates to the use of so-called plenoptic or light field cameras for obtaining images to be used in such positioning systems.

### BACKGROUND

Vehicles that can drive autonomously are becoming more commonplace. The sensors these known vehicles employ to maintain the right course on the road enable the driver, the vehicle or both to determine which objects on the road are relevant for a safe drive. For example, cameras may be configured in front and at the sides of the vehicle to identify road signs, lane separating striping etcetera. The systems are hereinafter called positioning systems, as they are aimed at determining the position of objects outside of the car. There are also positioning systems which are aimed at determining the position of the vehicle itself, but these are excluded from our definition. Whenever we refer to these vehicle position systems they will be referred to as such. In order to process the captured images and to determine if these objects are relevant for the safe drive of the vehicle these position data may be combined with position data of the vehicle positioning system, such as Global Positioning System (GPS) data, but the vehicle positioning system may also be based on other parameters, such as current, speed and direction of the vehicle. In other cases, only relevant distance between the vehicle and objects is needed as input for a safe maneuvering of the vehicle. For example, parking assistant devices comprise (sonar) sensors which enable to determine the distance between a sensor and an object. By audible or visual warnings, the driver may be informed in this way about the distance between the vehicle and an object, such as a parked second vehicle. There are also more advanced (or often called intelligent) parking assistant systems such as brought to market by Toyota Motor corporation wherein a control unit may take over all or some of the vehicle control systems, such as steering, cruise control, braking and acceleration. Current autonomous vehicle control systems based on sensor or camera input, with sensors such as ultrasonic sensors, RADAR, and/or LIDAR, have advantages and disadvantages. Ultrasonic sensors are inexpensive, but they are relatively inaccurate. For instance, ultrasonic sensors have difficulty detecting certain objects, such as curb shapes and even other vehicles, when the geometry and/or the material of the objects do not provide a strong return. Further, ultrasonic sensors do not output precise directional information because the ultrasonic sensor beam pattern is wide. LIDAR provides relatively good object range and heading information but is expensive. RADAR provides relatively good object range rate information, but has difficulty detecting some objects and is expensive. More advanced imaging systems using regular cameras which are only able to capture 2D images are limited in determining distance of objects. Either multiple cameras are required to create a 3D image, which is still not very accurate for determining distance without substantial processing power, or a combination with other sensor technology such as RADAR is needed for accurate positioning of objects outside of the vehicle. This becomes even more complicated when a vehicle is driving at a high speed.

It is an object of the invention to provide a solution for determining position of objects outside of a vehicle in an accurate and reliable manner. It is a further object of the invention to provide a positioning system which can be employed for a moving vehicle, moving objects or a combination of both. It is yet a further object of the invention to provide the positioning with means to increase vehicle safety for an autonomous vehicle.

### SUMMARY

This application is defined by the appended claims. The description summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

### DESCRIPTION OF DRAWINGS

For the convenience of reading below reference numbers are listed, wherein the numbers refer to equivalent numbers in the FIGURE.
100 The present invention as for example arranged in a vehicle 200, with cameras 101a,b,c and light sources 103a,b . . . g.
101a,b,c Light field (plenoptic) cameras.
102a,b . . . g Light sources.
200 Vehicle, preferably an autonomous vehicle.
300 Object.
1000a,b,c Field of vision of respective cameras 101a,b,c.
1001 Representation of single light beam e.g. as part of a broader light beam originating from light source 102a.

FIG. 1 shows a preferred embodiment of the present invention with light field cameras in a front portion of a vehicle.

### DETAILED DESCRIPTION

The invention is now described by the following aspects and embodiments, with reference to the figures.

In a first aspect of the present invention a positioning system for use in a vehicle comprising a plenoptic camera with a field-of-view arranged for obtaining a light-field image based on the field-of-view of an area is disclosed, wherein the positioning system further comprises:

a processor unit arranged for generating a depth map based on the image, whereby the depth map includes location information for objects in the image;

a control unit arranged for using the depth map for identification and/or classification of said objects;

the control unit further arranged for determining of a relevance of said objects in relation to a first speed and/or a direction of the vehicle and, based on said location information and determined relevance, generating a proposal for a second speed and/or direction of the vehicle.

The exemplary embodiments of the first aspect are as follows.

In a first embodiment of the positioning system, the vehicle comprises an autonomous vehicle.

In a second embodiment, the positioning system comprises multiple plenoptic cameras configured in an array.

In a third embodiment, the array comprises a horizontal array, whereby the multiple cameras are positioned at a distance from each other.

In a fourth embodiment, in conjunction with one or more cameras of the multiple cameras, the positioning system further comprises one or more light sources, arranged for directing light towards the point of view of the one or more cameras.

In a fifth embodiment, the control unit is arranged for controlling a sequence, wherein each of the cameras of the multiple cameras is arranged for capturing one or more images in said sequence, whereby the control unit is further arranged for determining a distance of an object in a captured image based on measurements of variations in the position of said object in a first image of a first camera of the multiple cameras in comparison with the position of said object in a second image of a second camera, whereby the sequence, the position of the camera and a viewing angle on said object is taken into account.

In a sixth embodiment, the light comprises light in the visible spectrum, infrared spectrum, or near infrared spectrum.

In a seventh embodiment, determining of a relevance comprises classifying said objects by assigning a level of relevance using a scale, whereby the lowest level is of class irrelevant and the highest level is of class dangerous or life threatening, and/or classes in between the scale.

In an eighth embodiment, the first speed and/or direction comprises the actual, planned, predicted or projected speed and/or direction respectively.

In a ninth embodiment, the second speed comprises a deviation from the first speed and/or direction respectively.

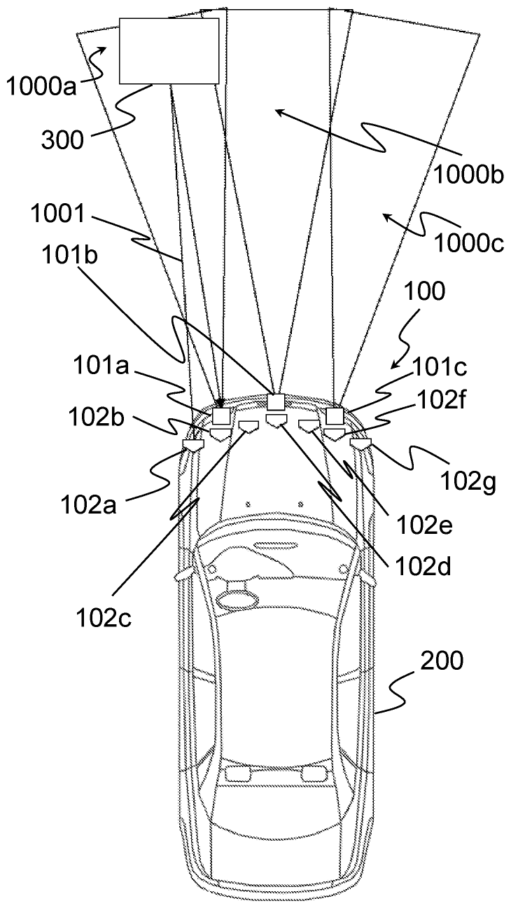

FIG. 1 shows a preferred embodiment of the present invention, wherein a light field camera array 101a,b,c (hereinafter referred to as “cameras”) is arranged in a front portion of a vehicle 200. In principle a single camera will suffice to obtain images in front of the vehicle. Adding cameras may be useful, however, to widen the field of view for example. By integrating, for example, front facing cameras 101a,b,c in the front of vehicle 200, a relatively wide area in front of vehicle 200 may be scanned for keeping track of possible obstructions on the road, which e.g. potentially cause a collision with vehicle 200, when vehicle 200 is moving towards such obstructions. Considering that cameras usually have limitations with respect to the viewing angle (as shown in the FIGURE by the areas representing fields of vision 1000a,b,c, the use of multiple cameras 101a,b,c, e.g. when positioned in a horizontal array, with each camera 101a,b,c spaced apart and/or positioned in spread out angle, increases the field of view.

For further improvement of the accuracy of determining of the position of object 300, additionally a light source or multiple light sources 102a,b . . . g may be arranged at the front of vehicle 3200 as well. On the one hand this increases the visibility of obstructions such as object 300. On the other hand, the light sources enable improvement of accuracy of the positioning of object 300 in the following manner.

It is proposed in the present invention that multiple, at least two, but preferably three light sources 102a,b . . . g flash in short bursts in rapid succession. Per flash an image is captured by at least one of the cameras 101a,b,c. The light sources 102a,b . . . g have a fixed position relative to the location of the cameras 101a,b,c and software is arranged for exact calculation of the distance and orientation of e.g. object 300 captured in the image.

Calculating the distance and orientation is for example performed by using trigonometric technology.

Scanning is performed by capturing multiple images by the cameras 101a,b,c. The FIGURE shows a situation wherein vehicle 200, which may be moving in a straight line forward may collide with object 300. Camera 101a, for example, is positioned in such a manner that it may detect object 300. Cameras 101a,c may be pointed slightly outward, whereas in the given example camera 101b may be pointed dead ahead. The field of vision of camera 101a is represented by triangular area 1000a. The characteristics of the light field camera 101a comprise that the image can be interpreted such that distance between camera 101a and object 300 can be calculated fairly accurately. In the calculation a compensation for speed of vehicle 200 may be processed as known to a person skilled in the art. In principle camera 101a is suitable for recreating a 3D image using the light field technology. In order to further refine measurements of distance from and of angle with vehicle 200, a captured image of camera 101a may be compared with a previous image of camera 101a, or with a current or previous image captured by any one of the other cameras 101b,c. In the FIGURE, field of vision 1000b overlaps to a certain extent with field of vision 1000a. Comparison of the level of overlap and/or position of object 300 in an image of camera 101a and camera 101b may be used to determine the angle of object 300 with vehicle 200.

The position of the cameras 101a,b,c, in vehicle 200 is known by these calculations and compensated for, so the position of vehicle 200 in comparison with object 300 may be determined.

It may suffice that cameras 101a,b,c are monochromatic, but full colour image capturing may add to an improved identification of objects, such as road signs.

Capturing multiple images in succession also allows for the software to calculate speed relative to the cameras 101a,b,c.

By implementing this invention, there is no need for complex Lidar type systems for example.

While the system of the present disclosure may be embodied in various forms, there are shown in the drawings, and will hereinafter be described, some exemplary and non-limiting embodiments of the invention. The present disclosure is to be considered an exemplification of the invention and is not intended to limit the invention to the specific embodiments illustrated and described herein. Not all of the depicted components described in this disclosure may be required, however, and some embodiments may include additional, different, or fewer components from those expressly described herein. Variations in the arrangement and type of the components may be made without departing from the spirit or scope of the claims set forth herein.

In order to understand the physical principles which are used for supporting the working of the present invention we will first explain the working of a plenoptic image sensor.

A plenoptic, alternatively referred to as multi-aperture—image sensor uses two lenses for forming an image onto a sensor. The first lens, similar to a conventional camera is the main lens with a big aperture. The second lens, called the microlens, is a set of small lenses placed at the focal plane of the first lens. This ensures that the main lens is fixed at the microlens' optical infinity as the microlens is very small compared to the main lens. Further, to ensure maximum utilization of the image sensor pixels the main lens and the microlens have the same f-number (the ratio of the system's focal length to the diameter of the entrance aperture). Each microlens has a set of pixels underneath it. The number of microlenses in a sensor determines its spatial resolution and the number of pixels underneath each microlens determines its directional (angular) resolution.

The present invention employs the technology of plenoptic imaging for determining position and distance of objects, which otherwise would be much more cumbersome when using conventional 2D imaging. Preferably the use of angle sensitive imaging as for example set forth in a thesis by Vigil Varghese, titled “Angle Sensitive Imaging: A New Paradigm for Light Field Imaging”, published in 2016

Use of the verb “to comprise” and its conjugations does not exclude the presence of elements or steps other than those stated in a claim. The term “and/or” includes any and all combinations of one or more of the associated listed items. The article “a” or “an” preceding an element does not exclude the presence of a plurality of such elements. The article “the” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

The term “substantial” herein will be understood by the person skilled in the art. In embodiments the adjective substantially may be removed. Where applicable, the term “substantially” may also include embodiments with “entirely”, “completely”, “all”, etc. Where applicable, the term “substantial” may also relate to 90% or higher, such as 95% or higher, especially 99% or higher, including 100%.

Many variations and modifications may be made to the above-described embodiment(s) without substantially departing from the spirit and principles of the techniques described herein. All modifications are intended to be included herein within the scope of this disclosure.

What is claimed:

1. A positioning system for use in a vehicle comprising a plenoptic camera with a field-of-view arranged for obtaining a light-field image based on the field-of-view of an area, wherein the positioning system further comprises:
a processor unit arranged for generating a depth map based on the image, whereby the depth map includes location information for objects in the image;
a control unit arranged for using the depth map for identification and/or classification of said objects;
the control unit further arranged for determining of a relevance of said objects in relation to a first speed and/or a direction of the vehicle and, based on said location information and determined relevance, generating a proposal for a second speed and/or direction of the vehicle.

2. The positioning system of claim 1, wherein the vehicle comprises an autonomous vehicle.

3. The positioning system of claim 1, wherein the positioning system comprises multiple plenoptic cameras configured in an array.

4. The positioning system of claim 1, wherein the array comprises a horizontal array, whereby the multiple cameras are positioned at a distance from each other.

5. The positioning system of claim 1, wherein, in conjunction with one or more cameras of the multiple cameras, the positioning system further comprises one or more light sources, arranged for directing light towards the point of view of the one or more cameras.

6. The positioning system of claim 1, wherein the control unit is arranged for controlling a sequence, wherein each of the cameras of the multiple cameras is arranged for capturing one or more images in said sequence, whereby the control unit is further arranged for determining a distance of an object in a captured image based on measurements of variations in the position of said object in a first image of a first camera of the multiple cameras in comparison with the position of said object in a second image of a second camera, whereby the sequence, the position of the camera and a viewing angle on said object is taken into account.

7. The positioning system of claim 1, wherein the light comprises light in the visible spectrum, infrared spectrum, or near infrared spectrum.

8. The positioning system of claim 1, wherein determining of a relevance comprises classifying said objects by assigning a level of relevance using a scale, whereby the lowest level is of class irrelevant and the highest level is of class dangerous or life threatening, and/or classes in between the scale.

9. The positioning system of claim 1, wherein the first speed and/or direction comprises the actual, planned, predicted or projected speed and/or direction respectively.

10. The positioning system of claim 1, wherein the second speed comprises a deviation from the first speed and/or direction respectively.
